(19) United States
(12) Patent Application Publication
(10) Pub. No.: US 2007/0208799 A1
(43) Pub. Date: Sep. 6, 2007

(54) SYSTEMS AND METHODS FOR BUSINESS CONTINUITY

(76) Inventor: William A. Hughes, Mankato, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/379,367

(22) Filed: Apr. 19, 2006

Related U.S. Application Data
(60) Provisional application No. 60/743,310, filed on Feb. 17, 2006.

(51) Int. Cl. G06F 15/16

(52) U.S. Cl. 709/203

(57) ABSTRACT

In an embodiment, a system for business continuity is described. The system may include, a central server, the central server including a virtualization module and an initialization module, and a local server, the local server located at a client location and providing one or more services to one or more users. The system may additionally include, in some embodiments, a network intermediary to monitor network communications between the one or more users and the local server. In an embodiment, a method of providing business continuity is described, the method comprising: receiving an indication that a server is unavailable, and initializing and executing a virtualized server environment, the virtualized server environment to perform one or more services offered by the unavailable local server.

### RELATED APPLICATION

This application claims the benefit of U.S. Provisional Application Ser. No. 60/743,310 filed Feb. 17, 2006, which application is incorporated herein by reference.

### TECHNICAL FIELD

This application relates to systems and methods for business continuity and more particularly to systems and methods that provide for continuity of operations in the event of catastrophic failure or disruption of one or more computing devices at a client location.

### BACKGROUND

As businesses use the internet to contact and communicate with their customers more and more, it is essential that those businesses be available to the customers. In the physical sense, a customer is familiar with hours of operation for a business. They know that the local bank is open from 9 a.m. to 5 p.m. every Monday through Saturday, for example. They expect the bank to be able to provide service during those hours, despite problems the bank may be having.

The bank typically has many contingency plans for various possibilities and scenarios. As an example, consider labor strike by the tellers at the bank. The operators of the bank, needing to provide service to their customers, has a plan to use management personnel to staff the teller's positions, and possibly operate at less then 100% efficiency, but still provide a level of service to the customer.

However, in the context of e-commerce, customers expect operations to be available at any time of the day or night. They desire to log onto the site and access the services whenever they need to. The customer may have no idea of the physical location of the business, nor do they really care. They just expect the operations to continue. Unlike the above example, where the bank is a local business and the customers are persons in the community that would know that the bank is having a strike and they need to make allowances for decreased service, the customer of an online business has no appreciation for the problems the business may be facing. What they see is increased wait times, failure to make connections, and poor customer service. What the business typically sees is a loss of those customers, as e-commerce customers tend to be more fickle in whom they choose to do business with.

### BRIEF DESCRIPTION OF THE DRAWINGS

Embodiments are illustrated by way of example and not limitation in the figures of the accompanying drawings, in which like references indicate similar elements and in which:

FIG. 1 shows a high level block diagram of a system for continuity of business operations, in accordance with an example embodiment;

FIG. 2A shows a high level block diagram of an apparatus for continuity of business operations, in accordance with an example embodiment;

FIG. 2B shows a more detailed block diagram of an apparatus for continuity of business operations, in accordance with an example embodiment;

FIG. 3 shows a block diagram of an apparatus for monitoring a server and providing for continuity of services, in accordance with an example embodiment;

FIG. 4 shows a flowchart of a method of customer initiated business continuity, in accordance with an example embodiment;

FIG. 5 shows a flowchart of a method of dynamically initiated business continuity in accordance with an example embodiment;

FIG. 6 shows a detailed block diagram of a system for continuity of business operations, in accordance with an example embodiment; and

FIG. 7 shows a block diagram of a machine including instructions to perform any one or more of the methodologies described herein.

### DETAILED DESCRIPTION

In the following detailed description of example embodiments, reference is made to the accompanying drawings which form a part hereof, and in which is shown, by way of illustration, specific embodiments in which the example method, apparatus and system may be practiced. It is to be understood that other embodiments may be utilized and structural changes may be made without departing from the scope of this description.

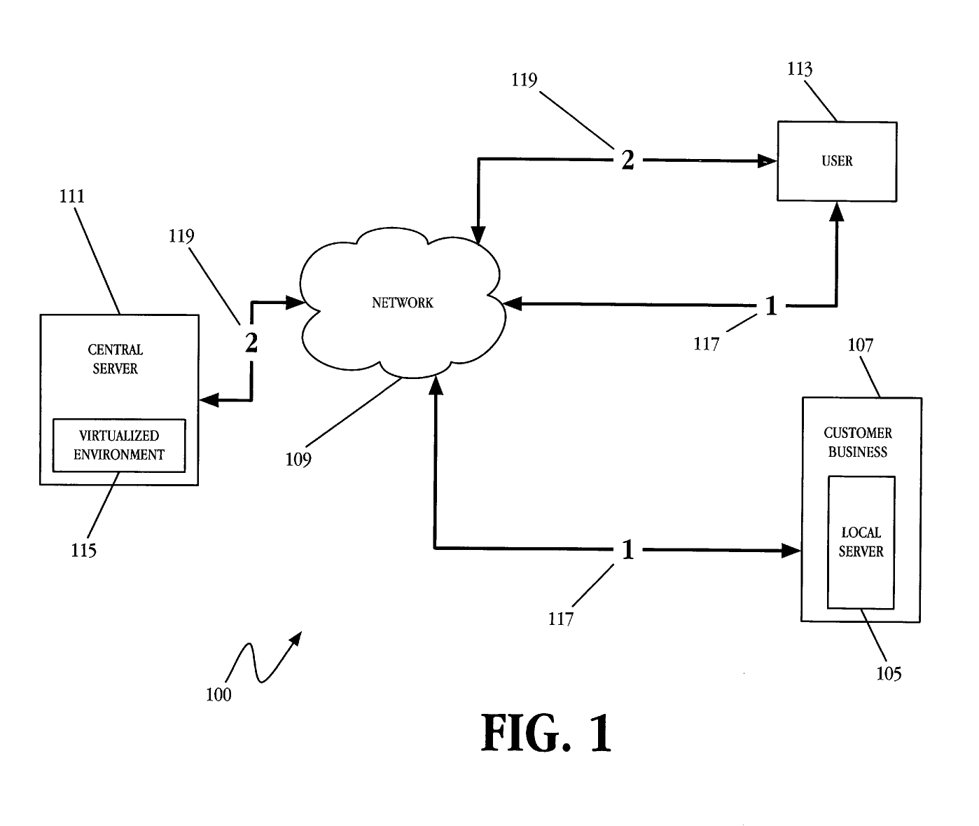

FIG. 1 shows a high level block diagram of a system for continuity of business operations, in accordance with an example embodiment. In an embodiment, the system 100 includes a local server 105 hosted at a customer business 107, a network 109 and a central server 111 accessible to the local server 105 through the network 109. Additionally, the local server 105 provides one or more business services to a user 113 across the network. The central server additionally includes a virtualized environment 115.

In an embodiment, the user 113 accesses one or more services available at the local server. In normal operations, where a communicative connection between the user and the local server is maintained, the path of the network communications is denoted by ‘1’ in FIG. 1. The local server is maintained at a customer business location. Customer business may include, without limitation, banking institution, financial services institution, application service provider and the like. However, there are times when the local server, or even the entire customer business location, may become unavailable to the user. Examples of such occurrences include, without limitation, destruction of the customer business location, maintenance of the local server, disruption of the network connection from the customer business location to the network 109, and the like. In such situations, the path of network communications is denoted by ‘2’ in FIG. 1.

In an embodiment, when the local server becomes unavailable the network traffic sent from the user's computer to the local server is redirected to the central server. In such an arrangement, the central server is configured to initialize a virtualized server environment. The virtualized server environment would emulate the services offered by the local server such that to the user, there has been little to no interruption in services. In one embodiment, the virtualized server environment maintains a data store of local server stored data such that when it is initialized it can reference that data without having to be manually loaded before beginning operations.

In an embodiment, during normal local server operations the state of the local server is sent to the central server. This may include, without limitation, memory state of all currently running processes, snapshot of one or more databases maintained and served by the local server, contents of specific memory pages, and the like. In a further embodiment, the state of the local server is stored by the central server in the data store.

Example operations using the system described so far with respect to FIG. 1 can be made. A user requesting services from the local server communicates through the network to the local server over a first communicative path 117. The local server responds to the requests and provides the services needed to the customer. As part of normal operating procedures, the local server periodically sends updates of the state of the local server to the central server for storage in a data store. In this example, the network connection of the local server is terminated by construction at the customer business. Without the systems described here, the user's connections would be terminated and the services not provided. Even if the customer business had redundant systems at the customer business location, the loss of the physical network connection removes the ability for those systems to take over the services of the local server. In this situation, the network traffic of the user is re-directed to the central server and uses a second communicative path 119. The central server receives some unavailability indication regarding the local server, or the customer business location. The central server retrieves the currently stored state of the local server and through the virtualized environment available at the central server, a virtualized server environment is initialized using the retrieved state and the local server's services are emulated at the central server. Through these operations, the user is able to carry on with the requested services and complete their task. In practical terms, some network traffic may be lost during this transition, which may be exacerbated by a catastrophic and unanticipated network outage, but the user should only experience a slight delay as the fail over operations commence. The end result is increased customer satisfaction even in the event of catastrophic loss of local server services. In an alternate example, the network outage may be a planned event. In such a situation, agents of the customer business can execute a planned hand over of services from the local server to the central server during the planned network outage. In this situation, there will be no delay in handling service requests, and the user should be able to request services and receive responses without any indication to them that there has been such a handover.

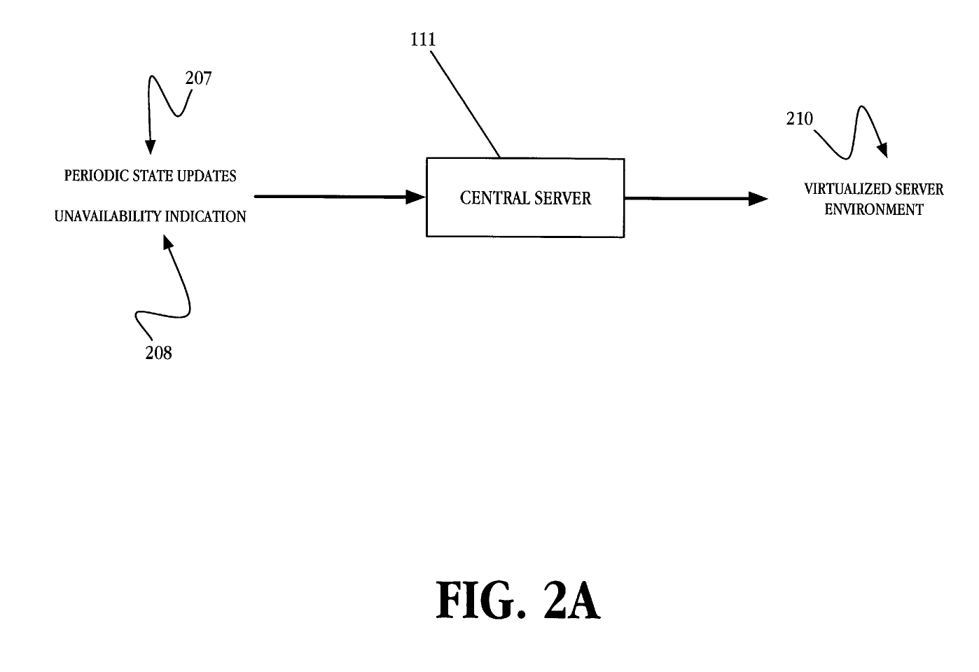

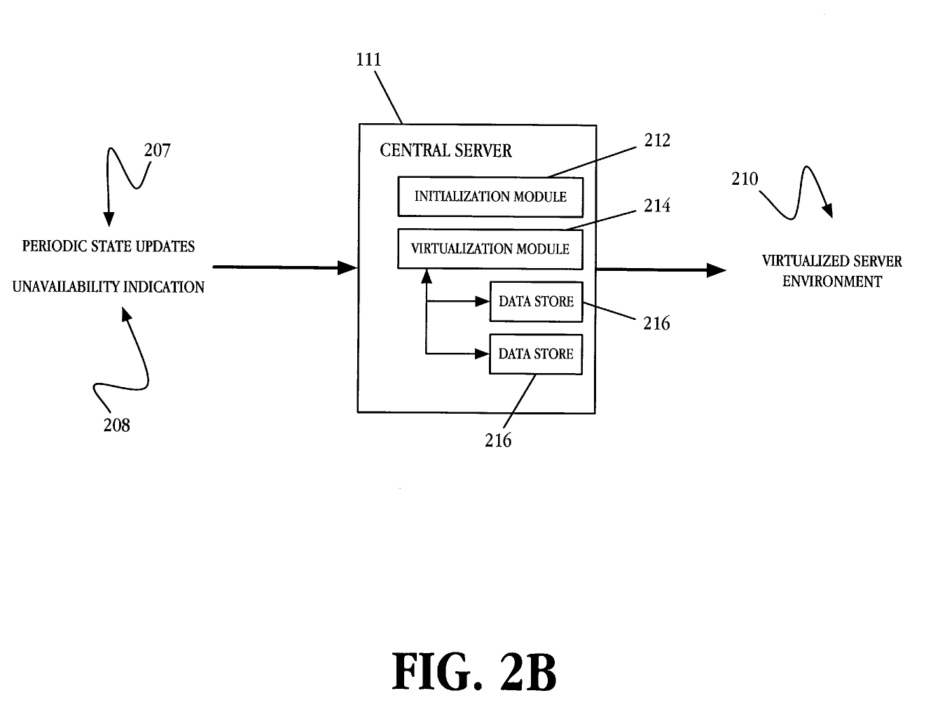

FIG. 2A shows a high level block diagram of an apparatus for continuity of business operations, in accordance with an example embodiment. In an embodiment, the central server 205 receives two inputs. During normal operations, the central server receives periodic state information 207. The periodic state information is stored in a data store and can be used in the eventuality that a virtualized server environment is required to maintain business operations for the business customer. During failure recovery operations, the central server additionally receives an unavailability indication 208 regarding a local server. During normal operations, the central server performs no other function then to receive the periodic state information and store it. During failure recovery operations, the central server outputs instructions to initialize and run a virtualized server environment 210.

FIG. 2B shows a more detailed block diagram of an apparatus for continuity of business operations, in accordance with an example embodiment. In an embodiment, the central server 205 includes an initialization module 212 and a virtualization module 214. In a further embodiment, the central server 205 includes one or more data stores coupled to the virtualization module 216. Though depicted as contained within the central server 205, it is to be understood that the one or more data stores 216 may be maintained separate from the central server 205, though remain coupled to the virtualization module 214 of the central server.

In an embodiment, the initialization module is configured to receive an indication that a local server supported by the central server is unavailable and to initialize a virtualized server environment. In a further embodiment, initializing a virtualized server environment includes sending instructions to the virtualization module, the instructions intended to cause the virtualization module to virtualize, or emulate, services offered by the local server in a virtualized server environment.

In an embodiment, the virtualization module is configured to store state information with respect to a local server, the state information defining a present computational state of the local server. In a further embodiment, the state information is periodically updated. The state information is stored in one or more data stores coupled to the virtualization module. In an embodiment, upon receiving instructions from the initialization module, the virtualization module, using the state information stored in the one or more data stores, initializes a virtualized server environment, the virtualized server environment configured to emulate the services offered by the local server. In an alternate embodiment, the virtualized server environment is configured to emulate a subset of the services offered by the local server. An example of such an arrangement may include where the virtualized server environment does not emulate services offered by the local server where those services are services only accessible to workstations at the client workstation. This removes a computational burden on the emulated server.

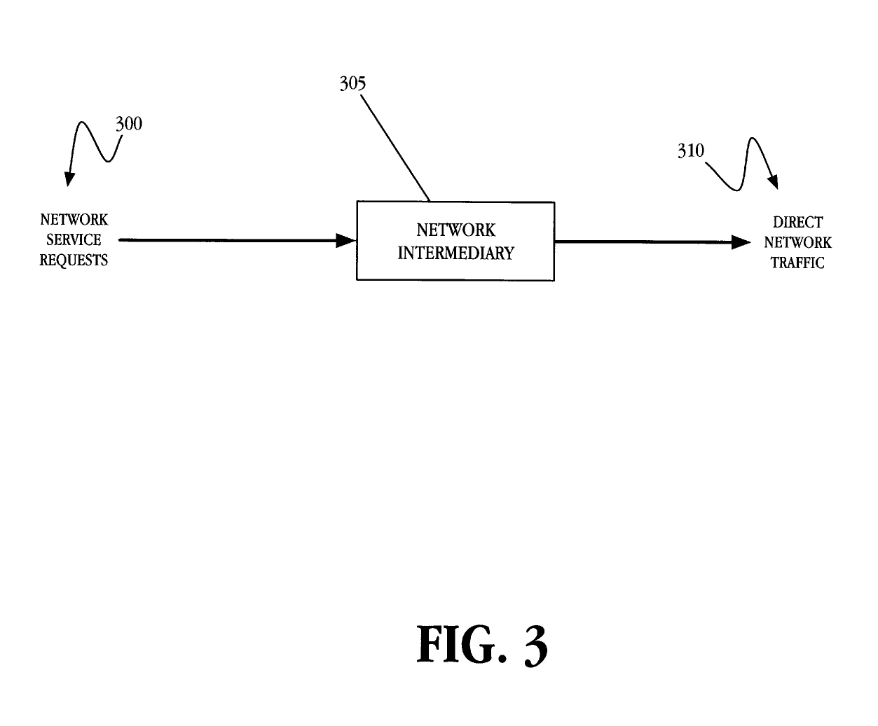

FIG. 3 shows a block diagram of an apparatus for monitoring a server and providing for continuity of services, in accordance with an example embodiment. In an embodiment, a network intermediary 300 is interposed between users of a service performed by a local server and the local server. In an embodiment, the network intermediary 300 receives one or more network service requests 302 as an input and directs network traffic 304 as an output. In one embodiment, the network service requests 302 are directed to the local server. In an alternate embodiment, the network service requests 302 are directed towards a virtualized server environment emulating at least some of the services offered by the local server.

In an embodiment, the network intermediary 300 monitors all network traffic flowing to the local server. The network intermediary may be placed anywhere in the network, so long as network service requests originating at a user pass through the network intermediary. This includes, without limitation, a server operating at a data center physically separated from the customer business, where all network traffic directed to the customer business is addressed to the server. One example of such addressing would be the use of the Domain Name Server (DNS) system to direct network traffic. As is well known in the art, a user computer, when receiving a Uniform Resource Locator (URL) as part of a web page request, will query a DNS server to translate the URL into an Internet Protocol (IP) address. For example, www.domain.com being translated to 1.1.1.1. Though the user types in www.domain.com into their web browser, the user's computer addresses all service requests to 1.1.1.1 at the transport layer. Implementing a network intermediary would require that instead of translating the URL into the IP address of 1.1.1.1, the DNS system would be configured to translate it into 2.2.2.2, which points to the intermediary server. The intermediary server seeing traffic intended for the local server at 1.1.1.1 would in turn direct the traffic to 1.0.1.1. Through this mechanism, all service requests intended for the local server would pass through the network intermediary.

By monitoring the network traffic going to the local server, the network intermediary can be configured to detect when the local server becomes unavailable. As network packets addressed to the local server are returned as unavailable, or fail, the network intermediary is configured to in turn send an unavailability indication to a central server. As is known in the art, some packet loss in transmission is expected, so a threshold for network packet loss that takes this into account may be used. Alternatively, in network connections where no network packet loss is expected, such as a hard-line network connection between the network intermediary and the local server, the threshold can be set to zero, such that a single network packet being lost, results in the unavailability indication being sent. One example of such an arrangement may be where a dedicated fiber-optic connection between the network intermediary at the data center and the local server at the customer business is used, without any connection to any other device in the network.

The unavailability indication sent from the network intermediary to the central server causes operations such as those discussed above with respect to FIG. 2A and FIG. 2B in some embodiments. In another embodiment, an agent of the customer business can be provided a login to the network intermediary and through such login communicate a scheduled interruption of services provided by the local server. An example of such an arrangement is a planned network outage for maintenance purposes. In order to maintain connectivity with the users, the agent sends a message to the network intermediary, which in turn sends a message to the central server, which initializes the virtualized server environment using updated state information retrieved from a data store. The network intermediary following these operations can then redirect network traffic from the local server to the central server. Through these operations, the customer business maintains connectivity with the users and the user experience with the services are greatly improved.

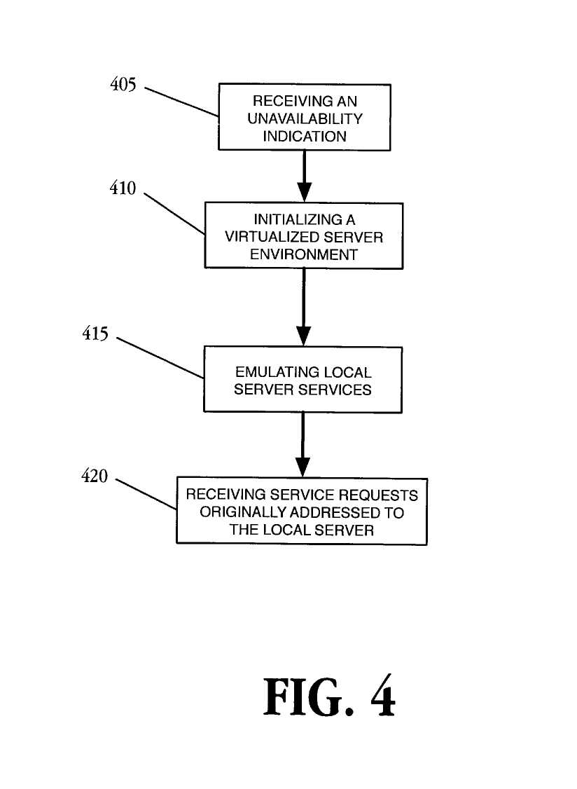

FIG. 4 shows a flowchart of a method of customer initiated business continuity, in accordance with an example embodiment. In one embodiment, the operations depicted in FIG. 4 and described here are carried out at a server device, such as the central server 205 described above with respect to FIG. 2A and FIG. 2B.

At block 405, an unavailability indication regarding a local server is received. The unavailability indication may be received from a network intermediary, in one embodiment, the network intermediary configured to monitor network traffic addressed to the local server. In an alternate embodiment, the unavailability indication is received by an agent of the customer business where the local server is operated. One example of such an arrangement is following a catastrophic loss of services at the customer business, like the building where the local server becoming destroyed in an explosion. In this example, an agent of the customer business, by logging in at any publicly available web terminal, can send a message to the central server indicating that the local server is no longer available and that the central server should take over the services of the local server.

At block 410, a virtualized server environment is initialized. The virtualized server environment is configured to emulate at least some of the services of the local server that has become unavailable. The virtualized server environment is initialized using the stored state information of the local server. At block 415, the virtualized server environment emulates the local server. Emulation includes, without limitation, responding to communications addressed to the local server as if the virtualized server environment was the local server. To a user accessing services offered by the local server, communication with the virtualized server environment should be no different then communications with the local server itself. This includes access to databases maintained or connected to the local server. In the case where the local server is coupled to one or more databases, the periodic updates of the state information sent from the local server should include database updates as well. At block 420, all requests for services addressed to the local server are received at the virtualized server environment.

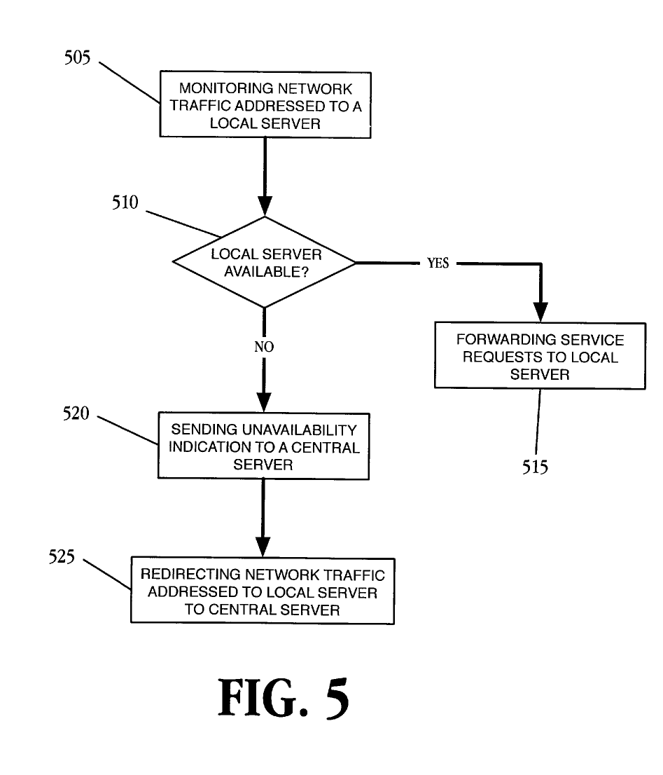

FIG. 5 shows a flowchart of a method of dynamically initiated business continuity in accordance with an example embodiment. In an embodiment, the operations depicted in FIG. 5 are carried out in a network device, such as the network intermediary discussed above with respect to FIG. 3.

At block 505, the network device monitors network traffic addressed to a local server, the local server maintained at a customer business. Monitoring the network traffic includes, without limitation, receiving network communications addressed to the local server, forwarding those network communications to the local server and determining if the network communications were delivered to the local server.

At block 510, the network device determines if the local server is available. In one embodiment, the network device determines the availability of the local server by the delivery of the network communications forwarded to the local server. In this example, the network communications forwarded to the local server would return as undeliverable were the local server unavailable. As discussed above, some network communications loss is expected in normal network operations, so the amount of loss experienced before the local server is deemed to be unavailable should be configurable. In an alternate embodiment, the network device receives a message from an agent of the customer business that the local server has become unavailable, or will be unavailable at some future point in time. In such an arrangement, the network device does not actively monitor the delivery of the forwarded communications and relies upon agents of the customer business to notify the network device of the unavailability of the local server. In either embodiment, if the local server is available, operations proceed at block 515 where the network traffic is forwarded to the local server. Such forwarding operations could also be termed normal operations, in some embodiments.

If it is determined at block 510 that the local server is unavailable, operations proceed at block 520 and an unavailability indication is sent from the network device to a central server. As discussed above, the central server is configured to initialize a virtualized server environment and emulate at least some of the services offered by the local server. The unavailability indication sent from the network device to the central server will cause operations intended to initialize the virtualized server environment, as discussed above with respect to FIG. 4. At block 525, the network traffic received by the network device that is addressed to the local server is re-directed to the central server. Such forwarding operations could also be termed fail-over operations, in some embodiments.

Though not depicted in FIG. 5, an additional category of operations is possible. Once the local server becomes available again, the network device can direct the network traffic back to the local server. Such operations could also be termed recovery operations. Prior to redirecting the network traffic back to the local server, several operations may need to be completed, in some embodiments. As discussed above, the local server sends periodic state information updates to the central server, so that when initialized the virtualized server environment can emulate the servers that the local server performs. In the reverse, that is once the local server becomes available, the state of the virtualized server environment can be captured and sent to the local server, which can then take up the services being performed by the virtualized server environment. Through these operations, the transfer of service response from the local server to the central server during fail-over operations and back to the local server from the central server during recovery operations, can proceed without interruption of services to the user.

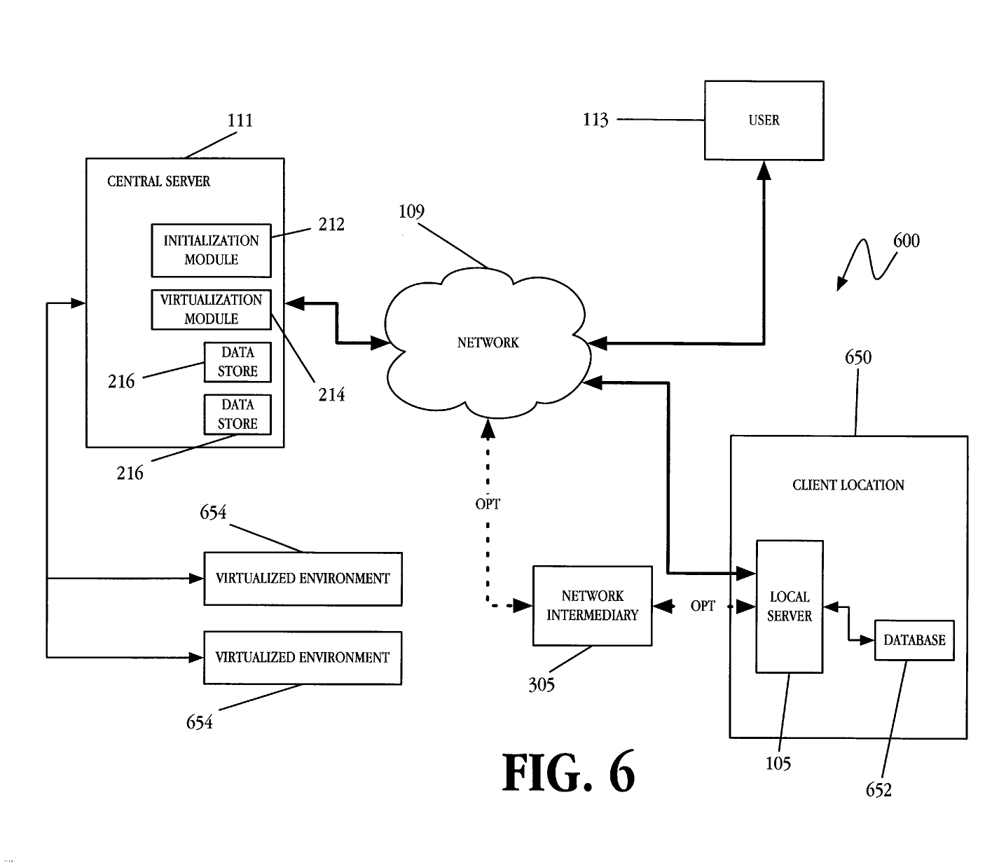

Various apparatus, systems and methods have been discussed with relation to business continuity operations. To further discuss and explain embodiments of the present invention, the apparatus, system and methods can be discussed with relation to an example system in FIG. 6.

FIG. 6 shows a detailed block diagram of a system for continuity of business operations, in accordance with an example embodiment. The system 600 includes a central server 111 and a local server 105 are coupled across a network 109. The local server 105 is located at a client location 650 and provides one or more services to a user 113. In one embodiment, the services are financial services.

The local server 105 at the client location 650 is coupled to a database 652, the database providing a data store to the local server. In one embodiment, the database 652 and the local server 105 are combined into a single computing device. The local server 105 provides one or more service to the user 113 and during normal operations, sends periodic updates containing state information to the central server 111. The central server 111 receives the updates and stores the state information in one or more data stores 216. In an alternate embodiment, the local server 105 sends database updates to the central server, such that the one or more data stores 216 mirror the database 652 coupled to the local server. In a further embodiment, the connection between the user 113 and the local server 105 has a network intermediary 305 interposed. In such an example, the network traffic between the user 113 and the local server 105 pass through the network intermediary 305 and the network intermediary is configured to determine the availability of the local server 105 either through monitoring of network traffic or through messages received by an agent of the client.

The central server 111 includes an initialization module 212 and a virtualization module 214. The central server 111 also includes one or more data stores 216, though the location of the one or more data stores 216 is not necessarily physically proximate to the central server 111 and may be accessed across a local area network, storage area network or a wide area network, such as the internet.

During normal operations, the user 113 requests services from the local server 105. The requests pass through the network intermediary 305, which determines the availability of the local server 105. For the purposes of the present illustration, the network connection to the client location 650 has been severed by a backhoe performing construction operations. In a first embodiment, the network intermediary 305 receives a message by an agent of the client of the network outage. This is advantageously very close in time to the actual network outage, but in practice could be much longer then a few minutes. For example, during a flood-induced evacuation, the time it takes for agents of the client to reach a network accessible terminal may be great. Users during this delay will not be able to access services provided by the local server. When the agent sends the message regarding the network outage, the network intermediary will redirect network traffic such that future communications to the local server are handled properly. In a second embodiment, the network intermediary determines that the local server is unavailable by the failure to receive network traffic. Through such operations, the need for an agent to send a message is removed and fail-over operations can proceed much more quickly. In a third embodiment, the network intermediary is omitted, and prior to the network outage the local server sends the unavailability indication to the central server. In such an example, an additional message to root level servers regarding the redirecting of network traffic addressed to the local server to the central server would need to be sent as well, otherwise, all network traffic addressed to the local server would be undeliverable without regard to a central server able to respond.

Following the receipt of the unavailability indication by the central server 111, the initialization module 212 causes one or more virtualized server environments 654 to be initialized. In one embodiment, the virtualized server environments 654 are initialized using the state information for a local server 216, the state information being stored on the one or more data stores 216. The virtualization module 214 upon receiving the instructions from the initialization module provides a conduit for the one or more virtualized server environments 654 to communicate to the user 113 through. The one or more virtualized server environments 654 provide at least some of the services that the local server provides to the users 113. In an alternate embodiment, the virtualized server environment is initialized using a database mirror that mirrors the database 652 coupled to the local server, the database mirror stored on the one or more data stores 216. In such an example, state information regarding the local server is not used to initialize the one or more virtualized server environments.

During recovery operations, network traffic is re-directed back to the local server. As discussed above, the state information for the one or more virtualized server environments is obtained and used to begin operations of the local server, in one example. In an alternate example, the database as it exists when recovery operations begin is mirrored back to the database coupled to the local server. Once the local server is in operation, the network traffic directed to the local server which has been re-directed to the central server can again be forwarded to the local server. In practical operations, some communications loss may be experienced during this handover, but normal network packet redundancy and error-correction will result in little to no external indication visible to a user 113 that a hand-over in operations has occurred.

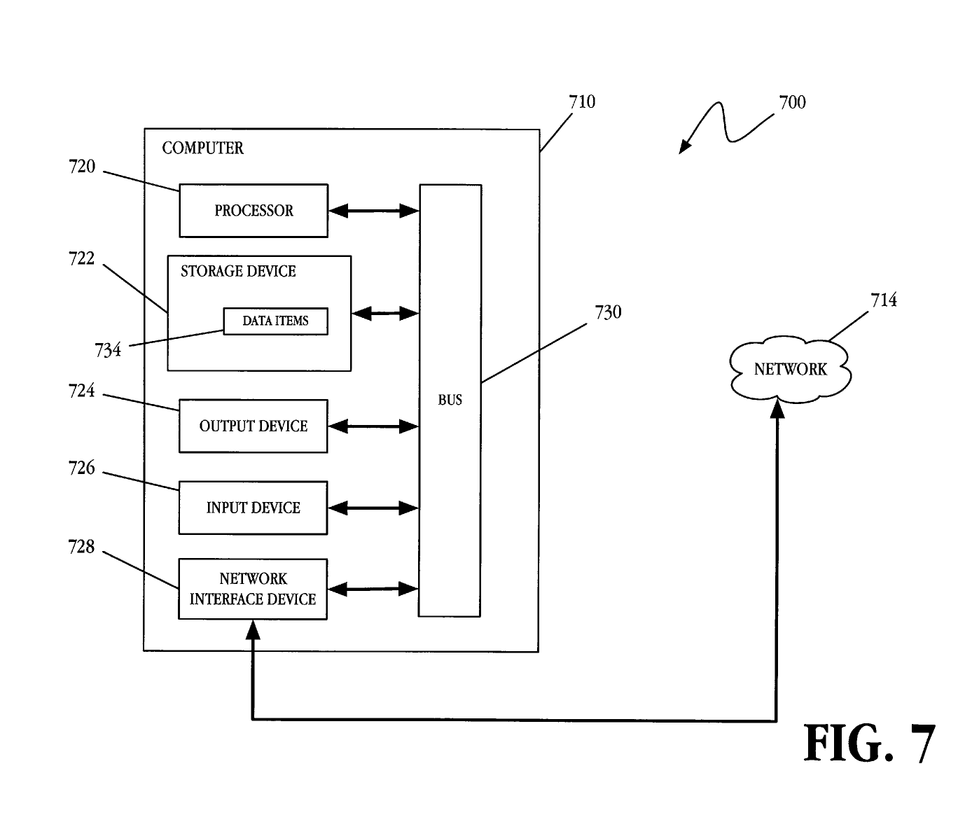

FIG. 7 shows a block diagram of a machine including instructions to perform any one or more of the methodologies described herein. A system 700 includes a computer 710 connected to a network 714. The computer 710 includes a processor 720, a storage device 722, an output device 724, an input device 726, and a network interface device 728, all connected via a bus 730. The processor 720 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 720 executes instructions and includes that portion of the computer 710 that controls the operation of the entire computer. Although not depicted in FIG. 6, the processor 720 typically includes a control unit that organizes data and program storage in memory and transfers data and other information between the various parts of the computer 710. The processor 720 receives input data from the input device 726 and the network 714, reads and stores code and data in the storage device 722, and presents data to the output device 724.

Although the computer 710 shows only a single processor 720 and a single bus 730, the present invention applies equally to computers that may have multiple processors, and to computers that may have multiple busses with some or all performing different functions in different ways.

The storage device 722 represents one or more mechanisms for storing data. For example, in an embodiment, the storage device 722 includes one or more memory devices such as, read only memory (ROM), random access memory (RAM), magnetic disk storage media, optical storage media, flash memory devices, and/or other machine-readable media. In other embodiments, any appropriate type of storage device may be used. Although only one storage device 722 is shown, multiple storage devices and multiple types of storage devices may be present. Further, although the computer 710 is drawn to contain the storage device 722, it may be distributed across other computers, for example on a server.

The storage device 722 includes a controller (not shown) and data items 734. The controller includes instructions capable of being executed on the processor 720 to carry out the functions of the present invention, as previously described above. In another embodiment, some or all of the functions of the present invention are carried out via hardware in lieu of a processor-based system. In one embodiment, the controller is a web browser, but in other embodiments, the controller may be a database system, a file system, or may include any other functions capable of accessing data items. Of course, the storage device 722 may also contain additional software and data (not shown), which is not necessary to understanding the invention.

Although the controller and the data items 734 are shown to be within the storage device 722 in the computer 710, some or all of them may be distributed across other systems, for example on a server and accessed via the network 714

The output device 724 is that part of the computer 710 that displays output to the user. The output device 724 may be a liquid crystal display (LCD) well-known in the art of computer hardware. But, in other embodiments the output device 724 may be replaced with a gas or plasma-based flat-panel display or a traditional cathode-ray tube (CRT) display. In still other embodiments, any appropriate display device may be used. Although only one output device 724 is shown, in other embodiments any number of output devices of different types, or of the same type, may be present. In an embodiment, the output device 724 displays a user interface.

The input device 726 may be a keyboard, mouse or other pointing device, trackball, touchpad, touch screen, keypad, microphone, voice recognition device, or any other appropriate mechanism for the user to input data to the computer 710 and manipulate a user interface. Although only one input device 726 is shown, in another embodiment any number and type of input devices may be present.

The network interface device 728 provides connectivity from the computer 710 to the network 714 through any suitable communications protocol. The network interface device 728 sends and receives data items from the network 714.

The bus 730 may represent one or more busses, e.g., USB (Universal Serial Bus), PCI, ISA (Industry Standard Architecture), X-Bus, EISA (Extended Industry Standard Architecture), or any other appropriate bus and/or bridge (also called a bus controller).

The computer 710 may be implemented using any suitable hardware and/or software, such as a personal computer or other electronic computing device. Portable computers, laptop or notebook computers, PDAs (Personal Digital Assistants), pocket computers, appliances, telephones, and mainframe computers are examples of other possible configurations of the computer 710. For example, other peripheral devices such as audio adapters or chip programming devices, such as EPROM (Erasable Programmable Read-Only Memory) programming devices may be used in addition to, or in place of, the hardware already depicted.

The network 714 may be any suitable network and may support any appropriate protocol suitable for communication to the computer 710. In an embodiment, the network 714 may support wireless communications. In another embodiment, the network 714 may support hard-wired communications, such as a telephone line or cable. In another embodiment, the network 714 may support the Ethernet IEEE (Institute of Electrical and Electronics Engineers) 802.3x specification. In another embodiment, the network 714 may be the Internet and may support IP (Internet Protocol). In another embodiment, the network 714 may be a local area network (LAN) or a wide area network (WAN). In another embodiment, the network 714 may be a hotspot service provider network. In another embodiment, the network 714 may be an intranet. In another embodiment, the network 714 may be a GPRS (General Packet Radio Service) network. In another embodiment, the network 714 may be any appropriate cellular data network or cell-based radio network technology. In another embodiment, the network 714 may be an IEEE 802.11 wireless network. In still another embodiment, the network 714 may be any suitable network or combination of networks. Although one network 714 is shown, in other embodiments any number of networks (of the same or different types) may be present.

The embodiments described herein may be implemented in an operating environment comprising software installed on any programmable device, in hardware, or in a combination of software and hardware.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An apparatus to provide continuity of services to users, the apparatus comprising:
a central server, the central server including:
a virtualization module, the virtualization module to store a state of a local server communicatively coupled to the virtualization module across a wide area network, the state defining the present computational state of the local server which is periodically updated; and
an initialization module to initialize a virtualized server environment using the state of the local server, the virtualized server environment to emulate the services provided by the local server and to store a state associated with the virtualized server environment.

2. The apparatus of claim 1, wherein the virtualization module is coupled to one or more data stores, the one or more data stores to store the state of the local server and to modify the stored state of the local server with periodic updates received from the local server.

3. The apparatus of claim 1, wherein the initialization module is to initialize the virtualized server environment following the receipt of an unavailable indication regarding the local server.

4. The apparatus of claim 3, wherein the unavailable indication is received from a human.

5. The apparatus of claim 3, wherein the unavailable indication is received from the local server.

6. The apparatus of claim 3, wherein the unavailability indication is received from a network intermediary.

7. A system providing business continuity to a customer business, the system comprising:
a local server, the local server to provide one or more services to a user of the customer business; and
a central server communicatively coupled to the local server across a network, the central server including:
a virtualization module, the virtualization module to store a state of a local server communicatively coupled to the virtualization module across a wide area network, the state defining the present computational state of the local server which is periodically updated; and
an initialization module to initialize a virtualized server environment using the state of the local server, the virtualized server environment to emulate the services provided by the local server and to store a state associated with the virtualized server environment.

8. The system of claim 7, further comprising:
a network intermediary, the network intermediary to monitor communications between the user and the local server and to send an unavailability indication regarding a local server is unavailable to the central server when such conditions exist, the network intermediary to further redirect network traffic addressed to the local server to the central server.

9. The system of claim 7, wherein the virtualization module is coupled to one or more data stores, the one or more data stores to store the state of the local server and to modify the stored state of the local server with periodic updates received from the local server.

10. The system of claim 9, wherein the one or more data stores mirror a database coupled to the local server.

11. A method of providing business continuity to a customer business, the method comprising:
receiving an indication from an agent of the customer business, the indication denoting that a local server operated by the customer business is unavailable to users;
initialized a virtualized server environment; and
emulating the local server at the virtualized server environment such that each of the users communicate with the virtualized software environment as if the virtualized software environment was the local server.

12. The method of claim 11, wherein indication is received from the agent at a central server, the central server comprising an initialization module and a virtualization module.

13. The method of claim 12, wherein the initialization module performs operations intended to execute the virtualized server environment.

14. The method of claim 13, wherein the virtualized server environment is executed by the virtualization module and is configured to respond to service requests as if the virtualized server environment was the local server at the client location.

15. The method of claim 11, further comprising:
receiving a further indication from the agent that the local server is available to the users;
sending the state of the virtualized server environment to the local server, the local server to load the state and continue operations; and
terminating the virtualized server environment.

16. A machine-readable medium having instructions contained therein, which when executed cause a processor to perform the following operations:
monitoring network traffic, the network traffic addressed to a local server that provides one or more services to the users;
determining if the local server is available;
sending an unavailability indication to a central server based on the availability of the local server; and
directing the network traffic based on the availability of the local server.

17. The machine-readable medium of claim 16, wherein the central server includes a virtualization module and an initialization module, the initialization module to receive the unavailability indication.

18. The machine-readable medium of claim 16, wherein directing the network traffic includes re-addressing the network traffic to the central server.

19. The machine-readable medium of claim 16, wherein directing the network traffic includes forwarding the network traffic to the central server.

20. The machine-readable medium of claim 16, wherein determining if the local server is unavailable includes receiving a message from an agent stating that the local server is unavailable.
